(19) United States
(12) Patent Application Publication
(10) Pub. No.: US 2025/0298588 A1
(43) Pub. Date: Sep. 25, 2025

(54) Responsive Design Transformer System And Methods Thereof

(71) Applicant: Nu Computing Abstraction Layer LLC, Bloomfield, NJ (US)

(72) Inventors: Melih Abdulahyoglu, Montclair, NJ (US); Yagmur Sahin, Ankara (TR)

(21) Appl. No.: 18/981,014

(22) Filed: Dec. 13, 2024

Related U.S. Application Data
(60) Provisional application No. 63/611,011, filed on Dec. 15, 2023.

(51) Int. Cl. G06F 8/34; G06F 3/0486; G06F 8/38

(52) U.S. Cl. CPC G06F 8/34; G06F 3/0486; G06F 8/38

(57) ABSTRACT

There is provided a Responsive Design Transformer (RDT) system and methods thereof which works with a no code environment that utilizes RDT to provide a fully responsive output for applications designed within its platform, ensuring compatibility with all device types. This applies both in preview mode and in the runtime output of the applications.

### CROSS REFERENCE TO RELATED APPLICATIONS

This application claims the benefit of and priority to U.S. Provisional Patent Application Ser. No. 63/611,011 filed on Dec. 15, 2023, and incorporated by reference herein in its entirely.

### FIELD OF THE INVENTION

The present invention relates to a system and methods for transforming responsive web design, and more particularly to a system and methods of a responsive design transformer for drag and drop interfaces and across a range of device types.

### BACKGROUND OF THE INVENTION

There have been several traditional methods employed to achieve responsive web design, especially in platforms using drag-and-drop interfaces. These methods, while effective to some extent, had limitations which need to be overcome.

One of the most common methods for creating responsive designs was using grid-based layouts. These grids provided a structured approach, where elements would align and resize according to predefined columns and rows. However, this method often lacked flexibility, as designers had to work within the constraints of the grid, which could limit creative freedom.

Media queries in Cascade Style Sheet (CSS) are another method. Media queries have been a staple in responsive web design. They allow designers to apply different cascade style sheet (CSS) styles based on the screen size, resolution, or orientation of the device. While powerful, this method requires a good understanding of CSS and meticulous planning to ensure designs respond correctly across devices.

Frameworks and Libraries: Several front-end frameworks and libraries, such as Bootstrap or Foundation, offer pre-defined classes and components to assist in creating responsive designs. These tools help standardize the process but can also lead to bloated code and a lack of uniqueness in design due to the overreliance on predefined components.

Manual Adjustment and Testing: Old methods often required designers to manually adjust layouts for different screen sizes and repeatedly test them across various devices. This was time-consuming and could lead to inconsistent results if not done meticulously.

Separate Mobile Versions: In some cases, developers would create separate versions of a website for mobile and desktop. This approach doubles the work and maintenance required and can lead to issues with content consistency and Search Engine Optimization.

Flexible and Fluid Layouts: Using flexible grids and layouts that use percentages rather than fixed units was another approach. While this method offered more flexibility than fixed grids, it still required considerable manual adjustment and testing to ensure compatibility across devices.

These methods, while foundational to the evolution of web design, presented challenges in terms of flexibility, efficiency, and ease of use, especially for users without extensive coding skills.

Extensive Coding and Handcrafted Methods: Traditional methods of achieving responsive web design often required a significant amount of handcrafted coding. This was especially true for making a web interface responsive. Developers and designers had to write and fine-tune vast amounts of CSS and HTML code to ensure that their designs would adapt correctly to different screen sizes and orientations. This process involved:
Detailed CSS Styling: Crafting comprehensive CSS to handle various aspects like layout, font size, image scaling, and more for different screen sizes;
JavaScript for Interactivity: Often, JavaScript was needed to handle certain responsive behaviors that couldn't be achieved with CSS alone.
Extensive Testing and Debugging: Each change often required rigorous testing across multiple devices and browsers to ensure consistent behavior, which was time-intensive.
Continuous Updates: As new devices and screen sizes emerged, websites and applications needed regular updates to their code to maintain responsiveness.
   These challenges highlighted the need for a more streamlined and efficient approach to responsive design.

The disadvantages of the old or existing methods of achieving responsive web design, as outlined above, are several and varied, impacting both the efficiency of the design process and the quality of the final product. These disadvantages include the following methods.

Limited Flexibility with Grid-Based Layouts: While grid systems provide a structured approach, they often restrict creative freedom. Designers are confined to the grid's limitations, which can hinder unique and innovative design solutions.

Complexity of Media Queries: Media queries require a deep understanding of CSS and meticulous attention to detail. This complexity can be overwhelming, especially for designers without extensive coding experience, leading to potential errors or inconsistencies in responsive behavior.

Overdependence on Frameworks and Libraries: Using frameworks like Bootstrap can lead to uniformity in design and bloated code. This over-reliance also limits the uniqueness of the design and can affect the website's performance due to unnecessary code.

Time-Consuming Manual Adjustment and Testing: Manually adjusting layouts and extensively testing them across various devices is a labor intensive process. It increases the time and resources required for development, potentially delaying project timelines.

Content Inconsistency with Separate Mobile Versions: Creating separate versions for mobile and desktop can lead to inconsistencies in content and functionality, as well as complicate maintenance and Search Engine Optimization efforts.

Challenges with Flexible and Fluid Layouts: Although more adaptable than fixed grids, flexible layouts still require significant manual effort to ensure proper display across different devices, which can be cumbersome and inefficient.

Extensive Coding Requirements: The need for detailed, handcrafted coding for responsive design is a significant barrier. It demands high-level skills in CSS, HTML, and potentially JavaScript, which can be a hurdle for designers and developers who are not coding experts.

Continuous Code Updates: The ever-evolving landscape of devices and screen sizes necessitates regular updates to the code, adding to the maintenance burden.

There is a need to overcome the above mentioned shortcomings and disadvantages for responsive web design.

### SUMMARY OF THE INVENTION

The present invention is a Responsive Design Transformer (RDT) system and methods thereof which is able to work with a no code environment that utilizes RDT to provide a fully responsive output for applications designed within its platform, ensuring compatibility with all device types. This applies both in preview mode and in the runtime output of the applications. The general technological area of no code development environment, enhanced by RDT, focuses on facilitating dynamic and responsive web design, particularly through a user-friendly drag-and-drop interface. This integration aims to overcome the limitations of static designs in codeless platforms, offering a more versatile and adaptive user experience. Platforms offered by NuCal LLC (“NuCal”) are suited for use with the present invention.

The present invention of RDT addresses these challenges stated previously by automating the responsive design process, offering a more intuitive and user-friendly solution that adapts seamlessly to various devices and screen sizes. By automating much of the process that previously required extensive coding and manual adjustments, RDT significantly simplifies the task of creating responsive web designs, making it more accessible to designers and developers of all skill levels.

The present invention of Responsive Design Transformer (RDT) is an innovative tool specifically developed to enhance the responsiveness and adaptability of web applications created on platforms like NuCAL, which utilize a drag-and-drop interface for design. The key purpose of the RDT is to ensure that applications and web designs are fully responsive and compatible across a wide range of devices, from desktops to mobile phones, without the need for manual adjustments or reliance on a grid structure.

With the present invention, particular solutions are accomplished with the RDT. These solutions include: 1.) Automated Responsive Conversion: The RDT uses a comprehensive transformer system, rules and method to automatically convert static, absolute-positioned elements in a drag-and-drop design into a dynamic, responsive layout. This ensures that the application output adapts seamlessly to various screen sizes and resolutions; 2.) Enhanced User Experience: By providing fluidity in web design across different devices, the RDT aims to significantly improve the user experience, ensuring that applications are not only functional but also aesthetically pleasing on any device; 3.) Overcoming No-Code Platform Limitations: Traditional no-code platforms often face challenges in achieving responsive design due to static element positioning. The RDT addresses this by enabling dynamic adjustments in element placement, size, and font without additional manual input, thereby streamlining the design process; 4. Device Compatibility and Flexibility: A major goal of the RDT is to make web applications universally compatible, catering to the diverse array of devices used in the modern digital world. This includes ensuring that designs remain coherent and functional across different operating systems and browser types; and 5.) Simplifying the Design Process: By automating the responsiveness of the design elements, RDT allows designers and developers, especially those with limited coding skills, to focus more on the creative aspects of web design, making the process more accessible and less technically demanding.

### BRIEF DESCRIPTION OF DRAWINGS

FIG. 1 is an illustration of the overview of the responsive design transformer system architecture of the present invention.

FIG. 2 is an illustration of the devices with breakpoints used in the present invention.

FIGS. 3A and 3B are illustrations of the breakpoints and gutter values in the present invention.

FIG. 4 is a flow diagram of the present invention.

FIG. 5 is a diagram of the initialization process of the present invention.

FIG. 6 is a diagram of the position and size adjustment process of the present invention.

FIG. 7 is a diagram of the grid layout and gutter identification process of the present invention.

FIG. 8 is a diagram of the breakpoint adjustment process of the present invention.

FIG. 9 is a diagram of the cascade style sheet (CSS) generation and media query utilization process of the present invention.

FIG. 10 is an illustration of the processors, memory, and storage devices within a computing device.

FIG. 11 is a schematic of an individual user operating a computer or handheld device which is connected to the internet.

### DETAILED DESCRIPTION OF THE INVENTION

The present invention of Responsive Design Transformer (RDT) system and methods thereof is designed to revolutionize the way web applications are created and rendered on various devices. Its primary purpose is to ensure that applications designed using drag-and-drop interfaces are inherently responsive, adapting seamlessly to different screen sizes and device types without the need for additional coding or manual adjustments. A detailed description of how RDT works, its construction, design, operation, and preparation follows.

The construction and design of RDT has three elements: a core system; an integration with drag and drop interfaces; and dynamic grid layout. The core system: At the heart of RDT is a comprehensive transformer system of rules. This system is designed to interpret and modify the layout of a web application, ensuring that every element dynamically adjusts to varying screen sizes and orientations.

The integration with drag-and-drop interfaces: RDT is particularly suited for platforms like NuCAL, which use free drag-and-drop structures with absolute positioning. It seamlessly integrates with these platforms, enhancing their existing functionalities without overhauling the fundamental design interface.

Dynamic Grid Layout: Unlike traditional static grid systems, RDT employs a dynamic grid layout. This layout is not restricted by fixed rows and columns but can adjust in real-time based on the device's screen size and resolution.

The operation and preparation has three parts: element responsiveness, breakpoints and media queries, and gutter standards and font algorithms and rules. These are described below.

Element Responsiveness: When a user designs an application, RDT automatically calculates the optimal placement, size, and font settings for each element based on the device it will be displayed on. This process eliminates the need for manual media query adjustments.

Breakpoints and Media Queries: RDT uses sophisticated methods to determine breakpoints—specific screen sizes at which the application's layout needs to change. It integrates these breakpoints into its algorithm, applying the appropriate media queries and CSS styles.

Gutter Standards and Font Algorithms: The system also incorporates gutter standards (spacing between elements) and font algorithms and rules to ensure readability and aesthetic appeal across devices.

The present invention provides numerous differences, additions, and improvements over existing methods. The present invention has automated responsiveness-unlike traditional methods that require extensive manual coding, RDT automates the process of making designs responsive. This automation significantly reduces the time and expertise needed to create a responsive application. The present invention also has flexibility in design as RDT offers greater design flexibility compared to grid-based layouts. Designers are not confined to rigid structures, allowing for more creativity and innovation in design.

The present invention also provides a reduction in testing and debugging. The need for exhaustive testing across multiple devices is greatly reduced, as RDT's system and rules ensures consistency in responsiveness. Also, separate mobile versions are not needed with the present invention. With RDT, there's no need to create separate versions of a website for different devices, as it ensures that the application is responsive across all platforms. The present invention is user-friendly for non-coders. The invention's technology makes responsive design accessible to individuals who may not have extensive coding skills, democratizing the process of web application development.

The Responsive Design Transformer (RDT) offers several significant advantages over traditional methods of achieving responsive web design, particularly in the context of drag-and-drop design platforms. These advantages underscore the innovative nature of RDT and its ability to streamline the web design process: 1.) Automation of Responsive Design: RDT automates the conversion of static designs into responsive layouts. This eliminates the need for extensive manual coding and adjustments, which were previously necessary to ensure that web applications function correctly on various devices. 2.) Enhanced Flexibility and Creativity: Unlike grid-based systems that restrict design elements to fixed rows and columns, RDT allows for greater flexibility and creativity. Designers are no longer confined to rigid structures, enabling more innovative and unique designs. 3.) Time and Resource Efficiency: The automation and simplification provided by RDT significantly reduces the time and resources needed to create a responsive design. This efficiency is particularly beneficial in reducing development timelines and costs. 4.) User-Friendly Interface for Non-Coders: RDT makes responsive design more accessible to individuals who may not have extensive coding skills. This democratization of web design allows a broader range of users to create professional-quality web applications. 5.) Consistency Across Devices: RDT ensures that web applications are consistently functional and aesthetically pleasing across all devices and screen sizes, a critical factor in a diverse technological landscape. 6.) Reduction in Testing and Debugging: The need for exhaustive testing across multiple devices and browsers is greatly reduced with RDT, as its algorithm is designed to ensure consistency and adaptability from the outset. 7.) As stated above, there is no need for separate mobile versions: With RDT, creating separate versions of a website for desktop and mobile is no longer necessary. This not only streamlines the development process but also ensures content consistency and simplifies maintenance. 8.) Seamless Integration with Existing Platforms: RDT is designed to integrate seamlessly with existing drag-and-drop platforms like NuCAL, enhancing their capabilities without requiring significant changes to their underlying architecture. 9.) Adaptability to Future Technologies: RDT's rules, methods and system approach positions it well to adapt to future technological changes and new device formats, ensuring long-term viability and relevance. The Responsive Design Transformer (RDT) represents a significant advancement in responsive web design technology. Its ability to combine automation, flexibility, and user-friendliness makes it a valuable tool for both professional web developers and those with less technical expertise.

The Responsive Design Transformer (RDT) brings forth several features and outcomes that are considered unexpected or surprising technological improvements, in view of the traditional methods of responsive web design.

The present invention has exceptional adaptability to varying screen sizes: this is one of the most unexpected outcomes of RDT. The exceptional ability to adapt web designs to a wide range of screen sizes, including those that may not have been explicitly considered during the design process is a technological improvement. This level of adaptability is a significant leap from traditional methods, where designs often needed specific adjustments for different screen sizes.

The present invention has high-quality design with minimal input: The quality of responsive design achieved with minimal input from the user is surprising aspect of RDT. Traditionally, achieving a high-quality responsive design required extensive coding and design expertise. RDT simplifies this, producing professional-level designs with far less effort.

The present invention of RDT has the ability to ensure a consistent user experience across not just current but also unforeseen or new devices is an unexpected benefit. This foresight in design adaptability is not typical in traditional responsive design methods, which often need updates to accommodate new devices.

The present invention has significant reduction in design and development time: The significant reduction in time required for both design and development phases with RDT is a remarkable outcome. The traditional approach to responsive web design is often time-consuming due to the need for manual adjustments and extensive testing.

Simplified Process for Non-Expert Users: The ease with which non-expert users can create complex, responsive designs is unexpected. Prior to the present invention of RDT, such a task would require considerable technical knowledge and skill in web development.

Automated Optimization for Performance: RDT's ability to not only adjust the layout but also optimize performance (like loading times and responsiveness) across different devices is a noteworthy feature. Traditionally, performance optimization is a separate, often complex task.

These unexpected results highlight the innovative nature of RDT, marking a significant advancement in the field of web design and development. Its ability to anticipate and adapt to a wide range of scenarios while simplifying the entire design process sets a new standard in responsive web design.

The Responsive Design Transformer (RDT) is a sophisticated software program developed to enhance the capabilities of no-code application development platforms, particularly in creating responsive web designs. Its primary purpose is to ensure that applications designed using a drag-and-drop interface are automatically adaptable to various device types and screen sizes, ensuring a seamless user experience across all platforms.

The purposes and functions of RDT include the following: Automated Responsive Transformation; Enhanced User Experience; Overcoming Limitations of Static Design; Streamlining Application Development; Ensuring Compatibility Across Devices and; Customization and Flexibility. Each are described below.

Automated Responsive Transformation; RDT utilizes a comprehensive transformer set of rules, system, methods and algorithm to automatically convert the application output into a fully responsive structure. This means that web designs created through the platform dynamically adjust to fit different screen sizes and devices without additional input from the user.

Enhanced User Experience: By making web designs compatible with various screen sizes and devices, RDT ensures a fluid and consistent user experience. This is crucial in today's digital environment where users access content through a multitude of devices.

Overcoming Limitations of Static Design: Traditional drag-and-drop platforms often result in static designs that do not respond well to changes in screen size. RDT addresses this by enabling dynamic adjustments in the placement, size, and font of the elements, ensuring that the application remains visually appealing and functional across different devices.

Streamlining Application Development: With RDT, the need for complex coding to create responsive designs is eliminated. This makes the application development process more efficient and accessible, especially for users without extensive coding knowledge.

Ensuring Compatibility Across Devices: RDT is designed to ensure that applications are compatible with every device, thereby broadening the reach of the platform and the applications it produces.

Customization and Flexibility: RDT offers strategies based on an analysis of device diversity and usage scenarios, allowing for the development of applications that are not only responsive but also tailored to specific user needs.

RDT represents a significant advancement in the field of web application development, particularly for no-code platforms. Its innovative approach to responsive design simplifies the process of creating adaptable web applications, making it more accessible and efficient.

The Responsive Design Transformer (RDT) introduces several novel aspects to the realm of web application development, particularly in the context of no-code platforms. Its uniqueness lies in how it addresses and overcomes certain limitations inherent in existing software products. These are described below.

Automated Responsive Design: One of the most significant innovations of RDT is its ability to automatically transform static designs into responsive layouts. Unlike many existing tools that require manual adjustments or extensive coding to achieve responsiveness, RDT simplifies this process, making it accessible to users with limited or no coding skills.

Integration with Drag-and-Drop Interfaces: While drag-and-drop interfaces are common in no-code platforms, they often result in static designs that do not adjust well to different screen sizes. RDT seamlessly integrates with such interfaces, enabling dynamic responsiveness without sacrificing the case and intuitiveness of the drag-and-drop experience.

Advanced Algorithmic Approach: RDT employs a sophisticated algorithm that goes beyond basic media queries and flexible grids. This algorithm considers a variety of factors like element placement, size, font settings, and screen breakpoints, ensuring a more comprehensive and effective responsive design.

Device Agnostic Design: RDT's approach is designed to be device agnostic, meaning it is capable of adapting web applications to a wide range of existing and even future devices. This foresight is not commonly found in other product or system offerings.

Elimination of Manual Responsive Adjustments: Traditionally, achieving a responsive design necessitates various manual adjustments, especially in no-code platforms. RDT eliminates this requirement, thereby saving time and reducing the potential for errors.

Customization Without Constraints: While RDT automates the responsiveness of designs, it still allows for a high degree of customization. This balance between automation and customization is a distinctive feature that is not typically offered in most existing solutions.

The present invention of RDT differs from other software in the following manner. 1.) Enhanced User Experience: RDT focuses on not just the functionality but also the aesthetics of responsive design, ensuring that applications are visually appealing across all devices; 2.) Simplification of complex processes: It simplifies the complex process of creating responsive web designs, which is often a major challenge in other software products; and 3.) Broad Accessibility: By integrating with no-code platforms, RDT makes responsive web design accessible to a broader audience, including those without technical expertise in web development.

The Responsive Design Transformer (RDT) is a sophisticated software module designed to revolutionize the way web applications are created and displayed across various devices. Its development is a response to the limitations inherent in many no-code application development platforms, particularly those employing a drag-and-drop interface. A detailed description and enablement of how RDT works follows.

A core functionality of the present invention is that RDT is integrated into no-code platforms, like NuCAL, which utilize a free drag-and-drop structure with absolute positioning for each element. A key function of RDT is to transform these statically positioned elements into a dynamic, responsive layout.

Responsive Transformation Method, System, Rules, and algorithm: RDT operates using a comprehensive transformer algorithm. This algorithm analyzes the layout created through the drag-and-drop interface and automatically adjusts the positioning, sizing, and font settings of each element to ensure that the application output is fully responsive.

Device Compatibility: RDT ensures that applications designed on these platforms are compatible with all devices, regardless of their screen sizes or resolutions. It dynamically adjusts the application's interface to provide an optimal viewing experience on any device.

Design Adaptability: RDT allows for the design of applications that are inherently adaptable. This means that the applications will not only look aesthetically pleasing but will also function efficiently across different devices without the need for additional settings or adjustments.

Dynamic Grid Layout: Utilizing CSS media queries, gutter standards, and font algorithms, RDT converts the design screen into a dynamic grid layout. This layout is not fixed but adjusts according to the device's screen size and resolution.

Overcoming Static Design Limitations: Traditional drag-and-drop platforms often result in static designs that fail to respond to different screen sizes. RDT addresses this by enabling elements to be responsive without restrictions, thereby overcoming one of the key limitations of such platforms.

The present invention is enabled as follows and has an integration with no-code platforms. RDT is specifically designed to be integrated into no-code platforms like NuCAL, enhancing their capability to produce responsive designs. There is also a user-friendly interface; The module maintains the simplicity and user-friendliness of the drag-and-drop interface, ensuring that even users without technical expertise can create responsive web applications.

The present invention includes automatic adjustment of elements. When a user designs an application, RDT automatically makes the necessary adjustments to ensure that the application is responsive. This includes modifying element sizes, positions, and font sizes based on the targeted device's screen.

The present invention has customization and flexibility. Despite its automation, RDT allows users to customize their designs while ensuring that these customizations do not hinder the responsiveness of the final application.

The present invention has a seamless user experience. The ultimate goal of RDT is to provide a seamless and fluid user experience, where applications designed on the platform are instantly and effectively adaptable to various devices.

RDT represents a significant advancement in the field of web application development, particularly for no-code platforms. It simplifies the process of creating responsive designs, making it more accessible to a broader range of users while ensuring high-quality, device-compatible output.

The overall architecture of the Responsive Design Transformer (RDT) system within the context of a no-code platform like NuCAL is designed to transform statically positioned elements into a dynamically responsive layout. This transformation is achieved through an advanced algorithm that treats each element as a part of a grid, considering various factors to ensure responsiveness across different devices. A detailed breakdown of the RDT system's architecture follows.

At its core, RDT operates as process on an algorithm focused on achieving dynamic responsiveness within a statically positioned area. The RDT algorithm aims to achieve a responsive layout in a statically positioned area by treating each element as an equivalent area in a grid. Each element on the page is considered equivalent to an area in a grid, with their positions adjusted to be relative and aligned with their respective parents.

The present invention provides for position and size adjustment of elements. Elements on the page have their positions adjusted to be relative, aligning them with their respective parent containers. A central variable maintains key attributes of each element, including width, height, top, left positions, and font size. Width and height values are set to 100% to ensure fluid responsiveness, while font sizes are adapted to be responsive.

The preset invention has a “Convergence Development Approach”. The RDT employs a ‘Convergence Develop’ approach, creating bounding box parent containers (referred to as convergence containers) to encircle and manage elements, preventing auto-placement. Each tab of an element is treated as a parent, and the algorithm operates separately for each parent, always starting by prioritizing the drop zone.

The present invention allows for grid layout creation, gutter identification and breakpoint calculations. Initially, RDT creates a grid layout for each element based on their initial positions, identifying gutters and calculating the layout for each row zone at different breakpoints. The algorithm identifies gutters (spaces between rows) in the initial layout and incorporates these into the responsive design.

The present invention allows for “Breakpoint-Specific Adjustments”. Breakpoints, specific to screen widths, guide the algorithm's layout adjustments. For each specific screen width (breakpoint), the algorithm recalculates layout adjustments for row zones. Rem values are scaled according to new breakpoints, and the area covered by elements is calculated.

The present invention includes layout design within parent containers. In scenarios where elements fit within the parent container without gutters, the covered area is directly written without adjustments. If elements don't fit at a new breakpoint, standard gutters are added, and the layout is re-evaluated. Auto-placement is initiated if elements don't fit, considering gutters before and after elements.

The present invention includes layout adjustments and auto-placement. The algorithm considers various scenarios, such as the fit of elements within parent containers and the presence of gutters, to determine the appropriate layout. Auto-placement is initiated in scenarios where standard layouts do not suffice, with the algorithm iteratively determining gutter placements for the best layout.

Column and Row Calculations: The algorithm identifies endpoints along columns, examining zones for auto-placement gutters and dividing these zones into sections. The algorithm divides auto-placement zones into smaller sections and calculates new column values based on this distribution. Column starts and ends are identified, and grid areas are recorded accordingly. New column values are calculated based on distribution, with standard gutters introduced between zones.

CSS Generation and Media Query Utilization: After all calculations, the system and process algorithm generates CSS rules, utilizing media queries to tailor styles for different breakpoints. Grid template columns and rows are defined for parent elements, assigning specific grid areas to page elements, with values written in rem for responsiveness. Font sizes are adjusted to rem format, ensuring adaptability to different screen sizes.

The present invention has steps of output and preview integration. Font sizes and other properties are adjusted to ensure adaptability across screen sizes, with values written in rem format. The CSS styles tailored to the grid are embedded directly into the code, both in the output and in the preview mode. Upon completion of the process, all recorded values are reset to their initial states.

The present invention has an iterative process and scaling for each parent and breakpoint. The entire process, from initial adjustments to layout calculations, is iterated for each parent and breakpoint. If elements still do not fit within the available space, the process scales the values again and revisits the layout for adjustments. After completion, all recorded values are reset to their initial state, ready for the next design iteration.

RDT system's architecture represents a comprehensive approach to converting static designs into responsive layouts. It encompasses an advanced algorithmic process that considers element positioning, sizing, parent-child relationships, and adaptive CSS generation, ensuring that web designs are responsive and visually appealing across various devices. This architecture enables RDT to transform applications designed with drag-and-drop interfaces into fully responsive designs, ensuring compatibility across various devices and screen sizes. The meticulous attention to element positioning, sizing, and the overall grid layout demonstrates the advanced nature of RDT's approach to responsive web design.

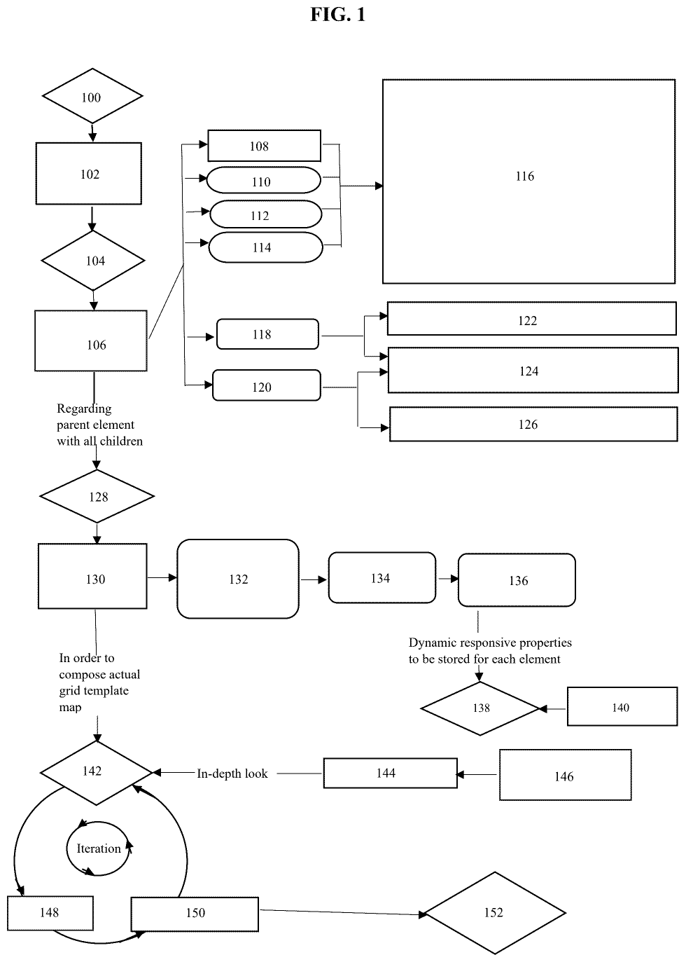

Referring to FIG. 1, there is shown the process of the present invention. The responsive design transformation process starts 100. First, the parent elements are identified and labeled with own values and children element values. (Step 102). Then, all elements to be processed have maps and grids prepared 104. The grid layout structure is rendered for each parent element to enter the whole rule (Step 106). Within this grid layout structure is included the screen (drop zone) 108, the linking block 110, section 112, and widgapp 114.

From these four items of the screen 108, the linking block 110, section(s) 112 and widgapp 114, the system architecture as seen in box 116 is doing auto placement, can be scaled, and checking from the minimum breakpoint whether it fits in the area. It also determines if a parent element that can be both scaled and automatically placed according to the pressed area. After auto-placement, breakpoint standards are applied to the inner rows. While scaling a parent's applied breakpoint standard optimal values to the inner and outer columns. As last outer row gutter, breakpoint standard is used, after auto placement standards are applied for the gutter between elements. Each parent's scale ratio is applied to all its children container(s) as growth or reduce. The system architecture recognizes a scaling situation and standard method applying the scaling. The font and image behavior are also recognized, with scaling and then spreading the element inside the parent element container.

Additionally, from the grid layout structure step 106, there is convergence 118, and button generator 120. For the convergence 118, there is no standard applied on row and column outer gutters 122. With both the convergence step 118 and button generator 120, it can be scaled and checked from the minimum break-point whether it fits in the area and a parent that can be both scaled and automatically placed according to the pressed area 124. The button generator also applies standards on outer columns when the content does not fit 126.

After the grid layout structure step 106 sequences are complete, the process continues with the parent element and all of its child containers. This next step includes the build grid layout step 128. Here, all grid layout and its needs are built for the initial responsive display (Step 130). The initial grid template columns and grid template rows are drawn by calculating screen width with its top/left values (Step 132). Then, find the initial grid area of each component with respect to where their top/left values are detected 134. By finding the “To be found” grid area values of each element (column area/row area) are stored in their inner object 136, with dynamic responsive properties to be stored for each element. This includes grid Area, row Area, column Area, and font/size 138. The parent grid layout is drawn with respect to parent initial values 140.

After the initial responsive display step 130 and the subprocesses (steps 132 to 140) described above are completed, in order to compose an actual grid template map. As seen in FIG. 1, the row based process comes into play next (Step 142). The details of this are that all row gutters are detected for each parent element (Step 144) and all partial gtc, gtr, column area numbers and inner column gutters are identified for each row (Step 146). The row based process 142 undergoes multiple iterations. For each iteration, all partials are collected 148 and for each break-point, row based pieces are put into an advanced algorithm (Step 150). As a result, the responsive design output is written to the application output (Step 152).

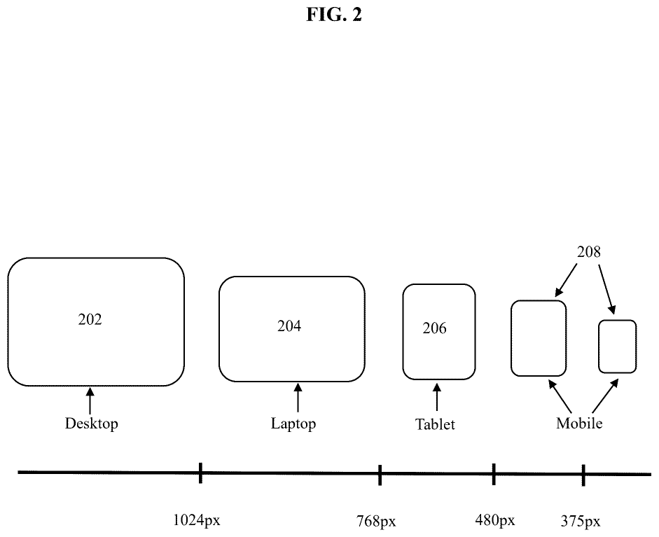

Referring to FIG. 2 illustrates various computing devices. As shown, there is a desktop 202, a laptop 204, tablet 206 and mobile devices 208. The scale below the devices indicates 1024 px, 768 px, 480 px, and 375 px. The desktop falls in the range above 1024 px, the laptop falls in the range between 1024 px and 768 px, and tablets are in the range between 768 px and 480 px. The mobile devices are in the range of 480 px to 375 px for larger mobile devices or 375 px or less for smaller mobile devices.

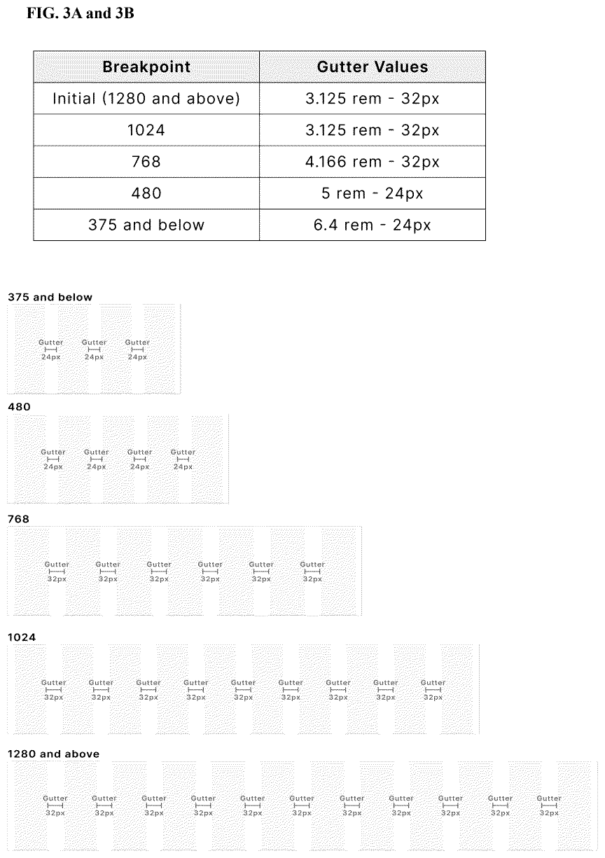

Referring to FIG. 3A, there is provided a table of breakpoint and gutter values. The breakpoints range from an initial value of 1280 and above to 375 and below. The gutter values are as indicated from 3.125 rem −32 px for the initial breakpoint value of 1280 and above and also the same for breakpoint at 1024. At breakpoint 768, the gutter value is 4.166 rem −32 px and at break point 480, the gutter value is 5 rem −24 px. The gutter value is 6.4 rem −24 px for a breakpoint of 375 and below. FIG. 3B is a display of gutter optimal according to the applied break points as indicated.

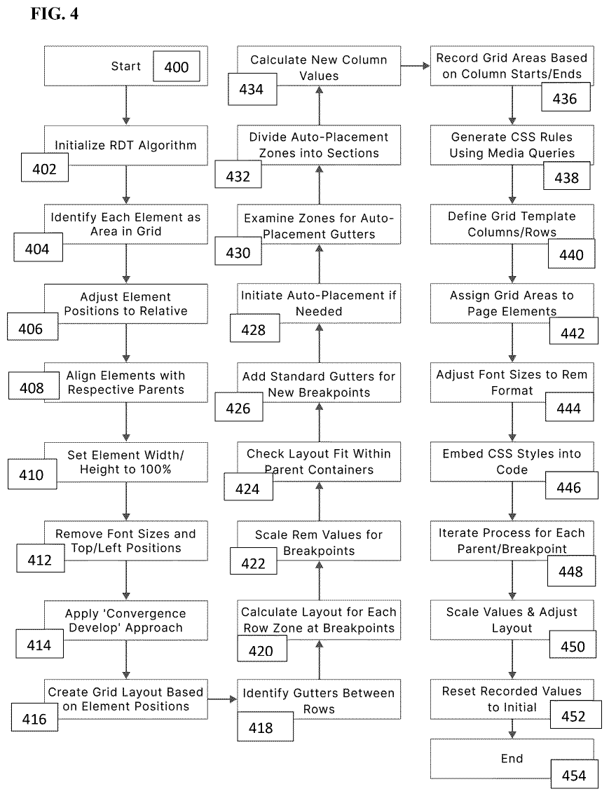

In FIG. 4, there is a flow diagram of the process with the present invention. The process starts (Step 400) and the RDT algorithm is initialized (Step 402). Then, the process identifies each element as an area in the grid (Step 404) and adjusts the element positions to the relative to respective parents (Step 406). Next, the process aligns the elements with their respective parents (Step 408) and then sets the element width/height to 100% (Step 410). Then, the process removes font sizes and top/left positions (Step 412). Next, the process applies a “convergence develop” approach (Step 414). The process then creates a grid layout based on element positions (Step 416).

Continuing as indicated with FIG. 4, the process then identifies gutters between rows (Step 418). The process then calculates the layout for each row zone at breakouts (Step 420). Next, the process scales rem values for breakpoints (Step 422). Afterward, the process continues by checking layout fit within parent containers (Step 424). Next, standard gutters are added for new breakpoints (Step 426) and if needed, initiate auto-placement (Step 428). The zones and locations for auto-placement gutters are then examined (Step 430). The process then divides the auto-placement zones into sections (Step 432) and calculates new column values (Step 434).

After calculating new column values in Step 434, the process records grid areas based on column starts/ends (Step 436). Then the process generates CSS rules using media queries (Step 438). From the rules, the process defines grid template columns and rows (Step 440). The process then assigns grid areas to page elements (Step 442). Then, the process adjusts sizes to rem formats (Step 444). Next, the CSS styles are embedded into the code (Step 446) and then iterate the process for each parent/breakpoint (Step 448). Next, the process scales values and adjusts the layout (Step 450) and resets recorded values to initial (Step 452), with the process then ending (Step 454).

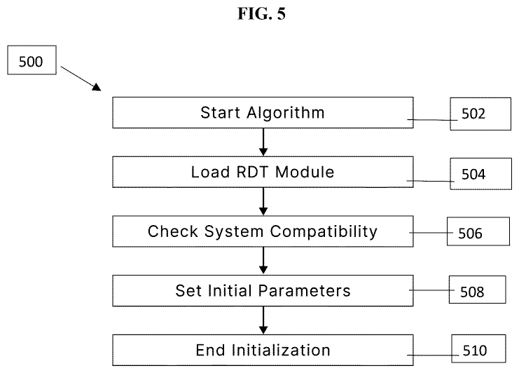

Referring to FIG. 5, there is shown an initialization process 500. In the first step, the algorithm starts (Step 502) and then loading of the RDT module (Step 504). Then, the process checks the system compatibility (Step 506). Next, the process sets the initial parameters (Step 508) and then the initialization ends (510).

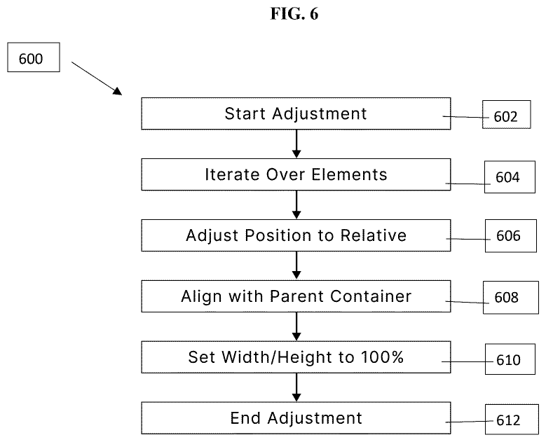

Referring to FIG. 6, there is shown the adjustment process 600. In the first step, the adjustment process is started 602. Then, the system and process iterates over elements (Step 604). The process then adjusts the position to relative to respective containers (Step 606). Then the process aligns position with the parent container (Step 608). Next, the height and width is set to 100% (Step 610). The process then ends the adjustment (Step 612).

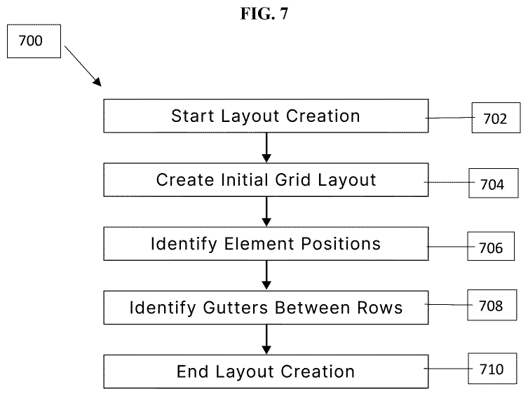

In FIG. 7, there is shown the process for layout creation 700. The process starts with layout creation 702. Then the initial grid layout is created 704. The process then identifies element positions 706 and identifies gutters between the rows 708. The process then ends the layout creation 710.

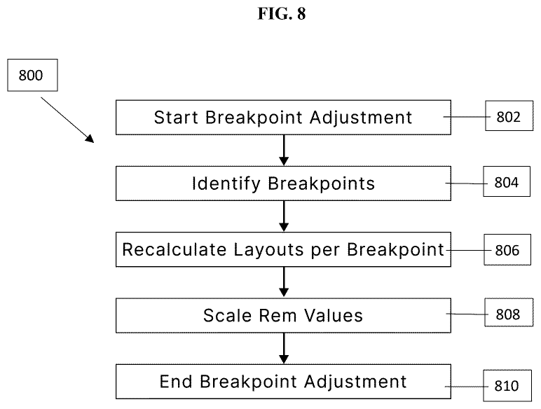

In FIG. 8, is illustrated the breakpoint adjustment process 800. The process indicated begins with starting breakpoint adjustment (Step 802), and then identifying break points (Step 804). From there, the process recalculates layouts per breakpoint (Step 806), and then scales the rem values (Step 808). Finally, the process ends breakpoint adjustment (Step 810).

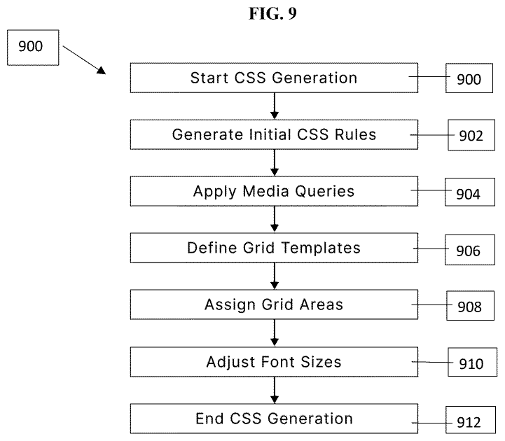

In FIG. 9, there is shown the CSS generation process 900. First, the system starts CSS generation (Step 900) and then generates the initial CSS rules (Step 902). Next, the system applies media queries (Step 904) and then defines grid templates (Step 906). Then, the system assigns grid areas (Step 908) and adjusts font sizes (Step 910). The CSS generation then ends (Step 912).

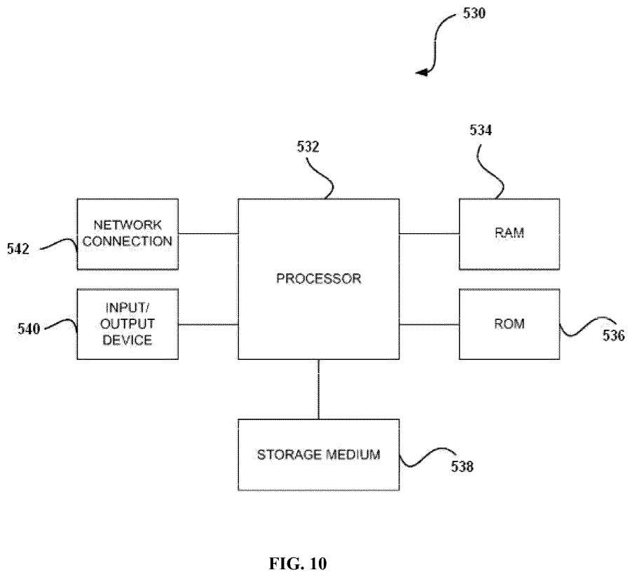

The system and method according to the present invention may be implemented on a computer system or devices, such as tablets or smart phone devices. The present invention may be implemented within a system with which may include substantially any suitable computing device. By way of example, the present invention may generally be implemented within an overall computing network which includes a plurality of computing devices. FIG. 10 illustrates a computing device or individual computer system suitable for implementing the present invention. A computing device or individual computer system 530 includes any number of processors 532 (also referred to as central processing units, or CPUs) that are coupled to memory devices including primary storage devices 534 (typically a random access memory, or RAM) and primary storage devices 536 (typically a read only memory, or ROM). ROM acts to transfer data and instructions uni-directionally to the CPU 532, while RAM is used typically to transfer data and instructions in a bi-directional manner.

CPU 532 may generally include any number of processors. Both primary storage devices 534, 536 may include any suitable computer-readable media. A secondary storage medium 538, which is typically a mass memory device, is also coupled bi-directionally to CPU 532 and provides additional data storage capacity. The mass memory device 538 is a computer-readable medium that may be used to store programs including computer code, data, and the like. Typically, mass memory device 538 is a storage medium such as a hard disk or a tape which is generally slower than primary storage devices 534, 536. Mass memory storage device 538 may take the form of a magnetic or paper tape reader or some other well-known device. It will be appreciated that the information retained within the mass memory device 538, may, in appropriate cases, be incorporated in standard fashion as part of RAM 534 as virtual memory. A specific primary storage device 536 such as a CD-ROM may also pass data uni-directionally to the CPU 532.

CPU 532 is also coupled to one or more input/output devices 540 that may include, but are not limited to, devices such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 532 optionally may be coupled to a computer or telecommunications network, e.g., a local area network, an internet network or an intranet network, using a network connection as shown generally at 542. With such a network connection, it is contemplated that the CPU 532 might receive information from the network, or might output information to the network in the course of performing the above-described method steps. Such information, which is often represented as a sequence of instructions to be executed using CPU 532, may be received from and outputted to the network, for example, in the form of a computer data signal embodied in a carrier wave. The above-described devices and materials will be familiar to those of skill in the computer hardware and software arts.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” or “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “computer readable storage medium” may be any tangible medium (but not a signal medium-which is defined below) that can contain, or store a program. The terms “machine readable medium,” “computer-readable medium,” or “computer readable storage medium” are all non-transitory in their nature and definition. Non-transitory computer readable media comprise all computer-readable media except for a transitory, propagating signal.

The term “machine-readable signal” refers to any signal used to provide machine instructions and/or data to a programmable processor. A “computer readable signal medium” may be any computer readable medium that is not a computer readable storage medium and that can communicate, propagate, or transport a program.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

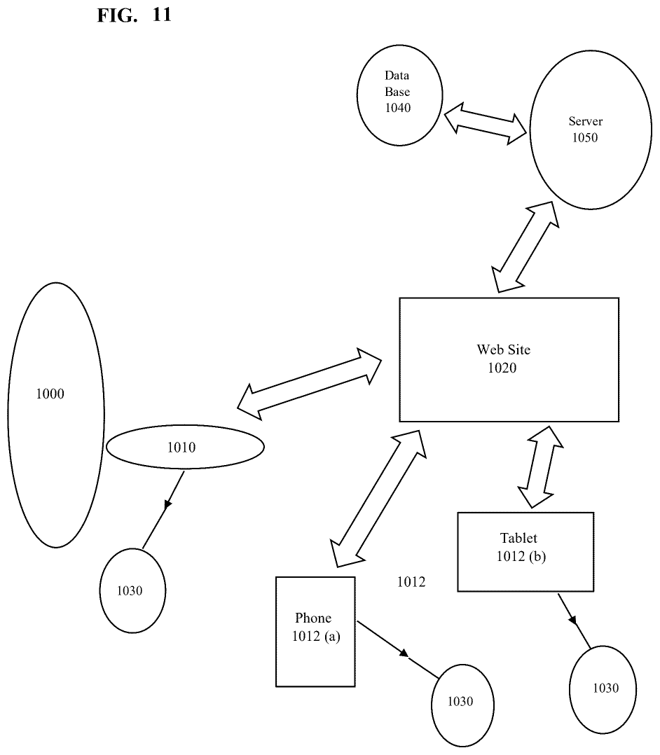

As shown generally by FIG. 11, there is a user 1000 of a computer 1010 or handheld device 1012 who accesses an Internet website 1020 with network connections to a server 1050 and database 1040. The computer 1010 or handheld device is compatible with operating systems known in the art, such as Windows, iOS or android devices or android type operating systems. The user 1000 is potentially exposed to many malicious or unsafe applications located on the web or a particular website 1020 due to lack of security and validation with the source, even though the website 1020 itself may be known as reliable and trusted. The website may be an application store or directory which includes other software applications for downloading. Similarly, receiving email may introduce unsafe internet links, applications and attachments to the user's computer or device. Those of skill in the art would recognize that the computer 1010 or hand held devices 1012a or 1012b each has a processor and a memory coupled with the processor where the memory is configured to provide the processor with executable instructions. A boot disk 1030 is present for initiating an operating system as well for each of the computer 1010 or hand held devices 1012. It should also be noted that as used herein, the term handheld device includes phones, smart phones, tablets, personal digital assistants, media and game players and the like. It should also be understood that the user's computer or device may be part of an internal network or system which is communicating with the Internet. As used throughout the specifications, the term “query” or “queries” is used in the broadest manner to include requests, polls, calls, summons, queries, and like terms known to those of skill in the art.

The invention is not restricted to the details of the foregoing embodiments. The invention extends to any novel one, or any novel combination, of the features disclosed in this specification (including any accompanying claims, abstract and drawings), or to any novel one, or any novel combination, of the steps of any method or process so disclosed.

What is claimed is:

1. A process for responsive design in a no code environment which is compatible across a range of devices without the need for manual adjustments, the process comprising the steps of:
identifying each element as an area in a grid;
adjusting positions of each said element to be relative to a respective parent element;
aligning each of said elements with said respective parent elements;
setting said elements width and height to 100 percent;
removing font sizes and top and left positions;
applying a convergence develop approach;
creating a grid layout based on said positions of said elements, said grid layout having rows and columns;
identifying gutters between said rows;
determining layout for each of said rows at breakpoint;
scaling rem values for said breakpoints;
checking layout fit within parent containers;
adding standard gutters for new breakpoints;
initiating auto-placement if needed;
examining zones for auto-placement gutters;
dividing auto-placement zones into sections;
determining new column values;
recording grid areas based on column starting points and ending points;
generating Cascade Style Sheet (CSS) rules using media queries;
defining grid template rows and columns;
assigning grid areas to page elements;
adjusting font size to rem format;
embedding CSS styles into code;
iterating said process for each parent and breakpoint;
scaling values and adjusting layout;
resetting recorded values to initial value.

2. The process for responsive design in a no code environment which is compatible across a range of devices according to claim 1 wherein said process is without the need for reliance on a grid structure.

3. A process for responsive design transformation in a no code environment which is compatible across a range of devices without a need for manual adjustments, comprising:
interpreting and modifying a layout of a web application by a core transformer system, said core transformer system integrating with drag and drop interfaces and employing a dynamic grid layout, said dynamic grid layout adjusting in real time based on a device screen size and resolution;
transforming statically positioned elements of said web application into a dynamically responsive layout by:
identifying parent elements of a design and labeling said parent elements with values of said parent elements;
identifying child elements of said parent elements and labeling said child elements with values of said child elements;
preparing a map and grid layout structure of all elements to be processed;
rendering said grid layout structure for each of said parent elements;
building a grid layout for an initial response display to compose an actual grid template map;
processing each of said parent elements by row based partial elements;
collecting all partial elements, including row based partial elements;
processing said row based partial elements for each breakpoint;
repeating said collecting of all partial elements and said processing of row based partial elements for each iteration until all rows are completed for a responsive design output;
writing said responsive design output to an application output.

4. The process according to claim 3 wherein said building a grid layout for an initial response display to compose an actual grid template map further comprises the steps of:
drawing initial grid template columns and initial grid template rows by calculating a device screen width with top value and left side values of said screen;
finding an initial grid area of each component with respect to their top and left values are detected;
storing in inner object grid area values to be found of each element by column area and row area;
storing dynamic response properties for each element, said dynamic response properties including grid area, column area, row area, and font size;
drawing a parent grid layout with respect to parent initial values.

5. A system for responsive design transformation in a no code environment which is compatible across a range of devices without a need for manual adjustments, comprising:
a core transformer system which interprets and modifies a layout of a web application, said web application having statically positioned elements;
said core transformer system integrating with drag and drop interfaces and employing a dynamic grid layout, said dynamic grid layout adjusting in real time based on a device screen size and resolution; and
said statically positioned elements of said web application transformed into a dynamically responsive layout.

6. The system for responsive design transformation according to claim 5 wherein said system automatically determines an optimal placement, size, and font settings for each element based on said device on which said element is displayed.

7. The system for responsive design transformation according to claim 5 wherein said system determines breakpoints of device screen sizes to change said application layout.

8. The system for responsive design transformation according to claim 5 wherein said system includes gutter standards for determining spacing between elements.
